(19) United States
(12) Patent Application Publication
(10) Pub. No.: US 2006/0277457 A1
(43) Pub. Date: Dec. 7, 2006

(54) Method and apparatus for integrating video into web logging

(76) Inventors: Carole T. Salkind, Rockaway, NJ (US); Edwin C. Cheung, Alhambra, CA (US)

Correspondence Address: LAW OFFICES OF DAVID L. HOFFMAN, 27023 MCBEAN PKWY, SUITE 422, VALENCIA, CA, 91355, US

(21) Appl. No.: 11/148,007

(22) Filed: Jun. 7, 2005

(51) Int. Cl. G06F 17/24

(52) U.S. Cl. 715/512

(57) ABSTRACT

An efficient, useful and practical way to integrate video into blogs such that the paradigm of text blogging can be applied to video. The user is provided the ability to post, revise, comment (and have others comment) on, syndicate and track video. Video is integrated into a blog environment such that blog-functions (e.g., posting, revising, commenting, quoting whole or sub-sets of video, syndication, tracking, etc.) are applied to video.

### FIELD OF THE INVENTION

The present invention relates to logging and in particular to web logging known as “blogging,” and most particular to integrating video into blogging over the Internet.

### BACKGROUND OF THE INVENTION

A web log (blog) comprises a journal that is available over the Internet and can be viewed using a web browser. The steps of updating a blog are termed “blogging”. A blog can be a web page that included publicly accessible journal, and is updated/maintained using specialized software. A blog can include text, links, postings, images and the like, in reverse chronological order.

Recent efforts have focused on including video in blogs. Some implementations have involved placing links into blog-pages that launch media players for playing videos wherein users of the blogs can provide text comments on the videos.

For text-blogs a user can comment on text, link other texts into the user's comments, “quote” subsets (e.g., spatial (objects) and temporal (time-line)) of text. By contrast, the conventional schemes of including video in blogs only amount to posting a video for users to provide comments about. Such schemes do not treat (or allow) video to be a fully-equal “Datatype” in the blogging experience the way text-blogs have been. Further, the conventional ad-hoc scheme of adding video does not provide blogging functions with the actual video. More specifically, while most conventional blogging approaches allow users to post text, link to external text or subsets of text (e.g., at other web sites) and allow users to comment on their postings using their own newly created text as well as quoting posted text (to highlight a point), these conventional blogging approaches do not provide such features for video.

One factor militating against such comments features for video that has been provided in a blog is that video files are quite large, and thus take substantial time and memory to copy, open, play, download and especially to edit. In addition, often or at least sometimes web users do not want to take the time to view a video. To comment on the video, instead of copying it and/or loading it into an editing program and editing it (something beyond many web users' capabilities from the standpoint of lacking software applications for video editing or at least knowing how to use video editing, as well as the standpoint of memory and computing power), one might simply say things like the following: “watch the first two minutes of the video in this blog,” or “watch from about halfway through to the end,” or even “watch for the person wearing the blue shirt in the background near the end of the video.”

Such comments are better than nothing, but still leave the comment reader having to load and view the video, and/or search through or watch the whole video or a large portion thereof. Many comment readers might pass over viewing the key segment or clip of the video. Accordingly, what is needed is a method and apparatus for commenting on videos in blogs that make it easy and quick to add video based comments and easy and quick to view video based comments, and pass on such video based comments as desired.

### SUMMARY OF THE INVENTION

In one embodiment the present invention provides an efficient, useful and practical method of integrating video into blogs such that the paradigm of blogging can be applied to video as it has been applied to text. In such an embodiment, a user is provided with the ability to post videos, revise videos, comment on videos, have others comment on videos, syndicate videos, track videos, etc. In one implementation of such a preferred embodiment, such features are accomplished by integration of video into a blog environment such that blog-functions (e.g., posting, revising, commenting, quoting whole or subsets of video, syndication, tracking, etc.) are applied to video. This allows a user to treat video (including tracked “objects” in the video) as if it were text in the context of modern text-blogging.

In one example, the present invention provides a Blog Page, including a VideoBlog Clickable-Video Player-Editor (“VBPlayer”), which allows a user to treat video essentially the same way as text. For example, a user can create a subset of the posted video for comment without actually editing the original video—but by making an “intelligent link” to the video. This subset can be a temporal subset which is specifying an in-point and out-point of the posted or other commented-on videos (or any video on the Internet for that matter). The user can also highlight (via provided tools) an “object” in a frame of the video under operation. The VBPlayer tracks the object frame to frame and generates a “link” that can be part of the user's comments which reference that object. Each link, when clicked, launches the VBPlayer that allows further “editing” on the video being watched, for further comments. In addition, the VBPlayer allows a video to be expanded by adding-together multiple videos into the target link. As such, a user can e.g. create a “video” for comment, wherein the video is a collection of multiple other videos or subsets (temporal or spatial thereof).

In a preferred embodiment, the segment (clip) and/or object or frame(s) from a video being commented on may simply be pointed to by the video integration method, which saves substantial time and computer memory. The video may even be edited. The video integration method may involve creating (by the commentator) a set of instructions that are stored e.g., on a server accessible over the internet (or intranet or other network or single computer). The instructions indicate or point to the start and/or end of a video segment or clip, contain any edit instructions, and/or other instructions for viewing a portion of the video, without having to copy the video, download it, or send it. For example, the instruction set with a link to the video can be sent to someone via email, or even a link to the video and another link to the instruction set stored on a server.

These and other features, aspects and advantages of the present invention will become understood with reference to the following description, and appended claims.

### BRIEF DESCRIPTION OF THE DRAWINGS

FIG. 1 shows an example layout of a VideoBlog Clickable-Video Player-Editor according to an embodiment of the present invention;

FIG. 2 shows example details of the Video Window and the URL Windows in FIG. 1;

FIG. 3 shows example details of the functions of the Video Controls and the Edit Controls in FIG. 1;

FIG. 4 shows example details of the URL Controls in FIG. 1;

FIG. 5 shows an example of a blog page according to an embodiment of the present invention;

FIG. 6 shows an example of watching/interacting with video using the Blog Page;

FIG. 7 shows an example of a viewer-launching URL from the Blog Page;

FIG. 8 shows an example of a user commenting on a video clip on the Blog Page;

FIG. 9 shows an example of a user editing a URL on the Blog Page;

FIG. 10 shows an example of a user tracking an object on the Blog Page;

FIG. 11 shows an example of a user creating a “play list” on the Blog Page;

FIG. 12 shows an example block diagram of a video web logging system according to an embodiment of the present invention;

FIG. 13 shows example functions of the vblog player in the system of FIG. 12;

FIG. 14 shows example functions of the XML server in the system of FIG. 12;

FIG. 15 shows a flowchart of example steps of watching a video in a blog in the system of FIG. 12;

FIG. 16 shows a flowchart of example steps of “Editing” a video in the system of FIG. 12;

FIG. 17 shows a flowchart of example steps of Inserting a URL in the system of FIG. 12.;

FIG. 18 shows a flowchart of example steps of launching a URL in the system of FIG. 12;

FIG. 19 shows a flowchart of example steps of Editing a URL in the system of FIG. 12;

FIG. 20 shows a flowchart of example steps of tracking an object in the system of FIG. 12; and

FIG. 21 shows a flowchart of example steps of generating a play list in the system of FIG. 12.

### DESCRIPTION OF THE PREFERRED EMBODIMENT(S)

The present invention allows a user to treat video (including tracked “objects” in the video) as if they were text in the context of modem blogging. While most conventional blogging approaches allow users to post text, link to external texts or subsets of texts and allow users to comment on their postings via new written text as well as quoting posting text (to highlight a point), such conventional blogging approaches do not provide such features for video. As such, the user can post, revise, comment and have others comment on, syndicate and track video. Integration of video into a blog environment according to the present invention provides video blog-functions such as e.g. posting, revising, commenting, quoting whole or sub-sets of video, syndication, tracking, etc. A tracking engine on a server keeps track of the user's in-out-object-splice actions (described further below) for any number of videos, and this information is used for later users to make further edits, etc. This results in a practical method of blogging with any video anywhere on a network such as the Internet.

In one implementation, the present invention provides a Blog Page, including a video blogging tool (“VBPlayer”), which allows a user to treat video essentially the same way as text. For example, a user can create a subset of the posted video for comment (without actually editing the original video—but by making an “intelligent link” to the video). This subset can be a temporal subset which is specifying an in-point and out-point of the posted or other commented-on videos (or any video on the Internet for that matter). The user can also highlight (via provided tools) an “object” in a frame of the video under operation. The VBPlayer tracks the object frame to frame and generates a “link” that can be part of the user's comments which reference that object. Each link, when clicked, launches the VBPlayer that allows further “editing” on the video being watched, for further comments. In addition, the VBPlayer allows a video to be expanded by adding-together multiple videos into the target link. As such, a user can e.g. create a “video” for comment, wherein the video is a collection of multiple other videos or subsets (temporal or spatial thereof).

The use, in the preferred embodiment, of links to video and video segments and/or objects and/or video frames, saves substantial memory and time. It makes it possible to quickly and easily comment on just a portion of a video and the reader can also easily view the specific segment of video to which the commentator is referring.

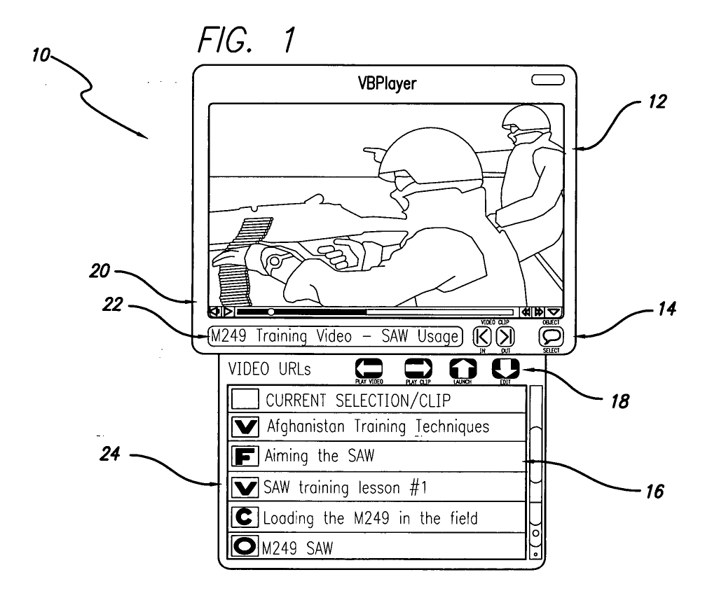

FIG. 1 shows an example implementation of the VBPlayer 10 which provides video blogging functions including clickable-video player-editor functions, i.e., the functions may be initiated by clicking on controls or buttons. Other types of control are also possible, e.g., key or function key-controlled, touch-controlled, etc. The VBPlayer 10 includes a Video Window 12, Edit Controls 14, a URL Window 16, URL Controls 18, Video Controls 20, a Current Video indicator 22 and URL Types indicator 24. The VBPlayer 10 is implemented in Flash and can use any of the standard media formats (e.g. QuickTime, Real, WM, etc.).

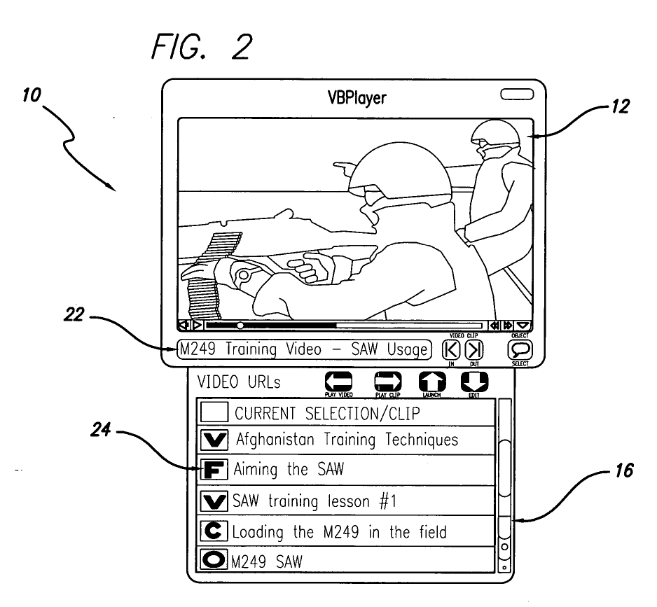

Now also referring to FIG. 2, example details of the Video Window 12 and the URL Window 16 of the VBPlayer 10 are shown. The Video Window 12 is where a selected video is played. While the video is playing, the user can click-on the video with a mouse. Each click generates a URL in the URL Window 16. (While “click” is used here to represent well-known selecting with a mouse, other methods of selecting a segment of video may be used, e.g., function keys, etc. as noted above.)

The URL Window 16 captures URLs that correspond to clicks made in the playing video above. Each URL is of a “type” when selected and can be “controlled” by the URL Controls 18 (FIG. 1). Example URL Types include “V” for next to the URL, means it is a “Video” URL—that is a URL that when used (in blogging) will invoke a full video; If the URL has “C” for Clip the URL represents a (temporal) subset of a video (with an in-point and an out-point); If the URL is preceded in the player with an “F” it represents a “Frame” URL, a subset of a video that is a single-frame—essentially a still-image; and if the URL in the player is prefixed with an “O” then the URL represents an “object” in the base-video being used (video as in blog), when invoking this URL the frames with that object are rendered (and the object optionally highlighted).

The Current Video indicator 22 shows e.g. the name of a currently playing video, wherein right-clicking the Current Video indicator 22 results in “launching” the URL of the video being played. The first URL (“magic”) corresponds to the current video selection and is always present. In other words, the URL representing the selected video from the blog, from which the URL Types 24 are listed, and from which video clips are being displayed in the video window, does not change until a new selection is made, as described elsewhere herein.

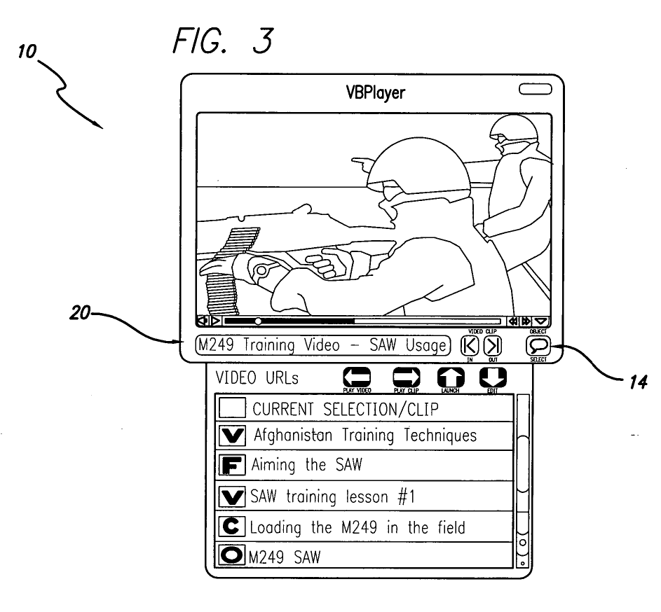

FIG. 3 shows example details of the functions of the Video Controls 20 and the Edit Controls 14 of the VBPlayer 10. The Edit Controls 20 include Select, In and Out, which allow the viewer to “Select” a video “In” point (start point) and an “Out” point (stop point), which thereby defines a selected “clip or region” of the playing video. The clip thus becomes the focus of interaction. This is simply a short-hand way to select only a desired portion of a video to play and typically a video in and video out selection function is standard with most personal computer media players in which you can shift-click in-out with the video controller. For example, in most video players and in the VBPlayer (also) one can select a segment of video by moving the time-line slider to the desired in-point, and then holding down the keyboard's shift-key and the clicking on the location on the time-line for the desired out-point (much like one selects a segment of text in a typical text editor). There may also be an Object Select key or function which allows the selection of an object in the video frame wherein a tracking engine tracks that object in subsequent frames.

Marking video “In” is the same as Movie shift-scrub to in-point, wherein scrub is the term-of-art that means moving the time-line slider back-and-forth while watching the video results to identify an in or and out point desired. Marking video “Out” is the same as shift-scrub to out-point (shift while scrubbing keeps or saves the video selected from the point of the in-point). Select video object function uses the tracking engine stored, e.g., in a server back-end to process the video using object-tracking and generate an “Object” URL in the magic first URL. In one embodiment, the tracking engine is implemented on a server and keeps track of the user's select-in-point, select-out-point, select(track) object and splice (multiple-videos or clips together) actions for any number of videos. A suitable video object tracking function is disclosed in pending U.S. patent application Ser. No. 10/443,301, filed May 21, 2003, hereby incorporated by reference. The VBPlayer 10 uses this information for later users to make further edits, etc.

The Video Controls 20 include Volume, Play/Pause, Time-line position and scrub back/forth (scrubbing is the process of dragging the time-line position indicator to quickly move the video forward or backward), Fast Reverse, Fast Forward, Save and Options (not shown). The Video Controls 20 allow the user to watch video, Select In-Out by highlighting and performing tasks the user understands about typical video players. Any selection of video is reflected in the Current Selection/Clip URL in the URL Window 16.

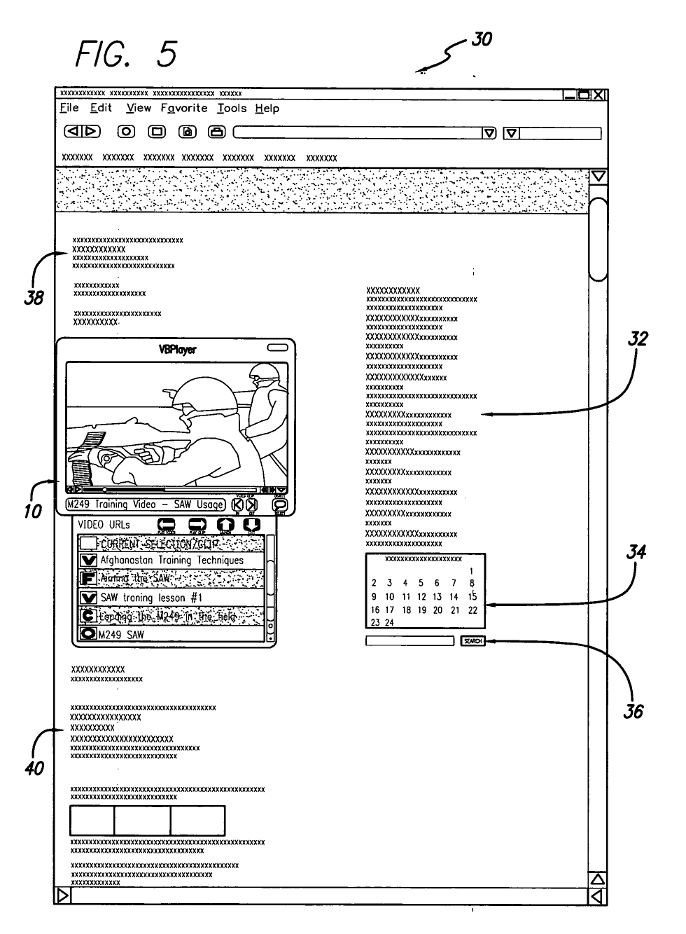

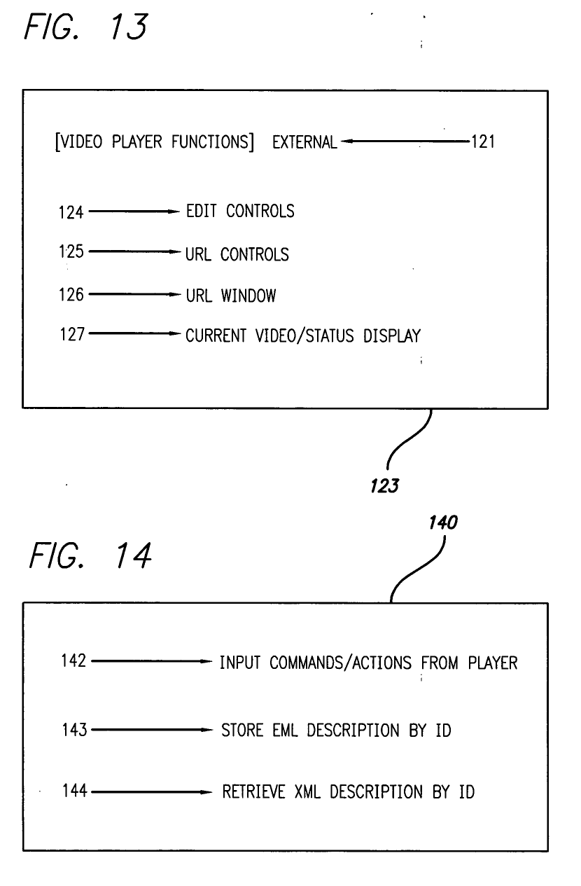

The Video Controls 20 and the Edit Controls 14 effect the “magic” first URL in the URL window 16 (creating of a “magic” first URL is further described in conjunction with the flowcharts in FIGS. 15-21 further below). Whatever URL is selected is represented by the first URL in the URL window 16. The selected URL can be copied/pasted into a blog and represents the blogger's edits of the video. When the URL is invoked (in any context) the VBPlayer is launched and renders or plays the video as the blogger intended. Since the VBPlayer 10 also contains the ability to “edit” when the user presses the “edit button” in the URL controls 18, then anyone (if permitted by the video's permissions) watching this video, invoked by the aforementioned URL, can make their own edits, generating another URL that will invoke that user's edits for anyone else to see (when URL is posted into the blog). When these (selected URLs) are invoked in edit-mode (edit-button in URL controls 18), the VBPlayer will populate all the URLs that went into the previous edit of the selected clip into the URL window 16 and those URLs can be edited, deleted, added-to, etc. The result is always represented by the VBPlayer's version of the “magic” first URL. This URL is always the first URL in the URL window —and can be thought of as the URL that represents the current state of the editing process. This URL can be copied/pasted into a blog page (e.g., FIG. 5) to represent and to correspond to the changed video e.g., as stored (the set of instructions as to how to change the video).

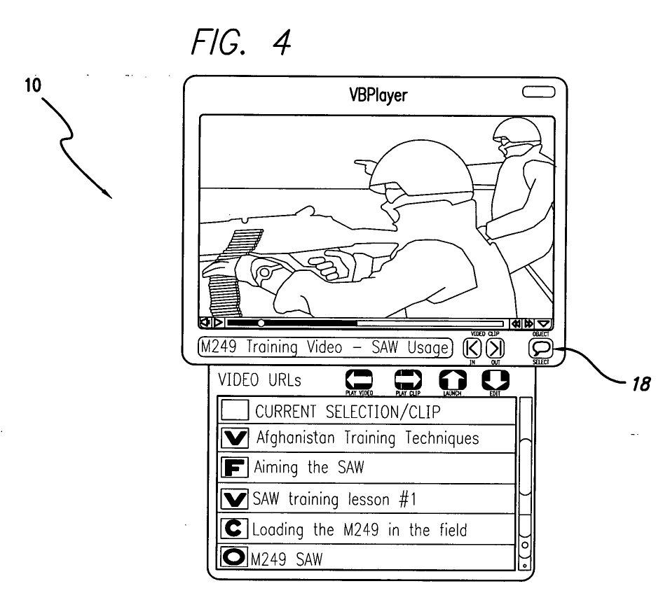

FIG. 4 shows example details of the URL Controls 18 of the VBPlayer 10, including: Play Video, Play Clip, Launch and Edit. Upon selecting the URL: (1) the Play Video control can be clicked to play video from the selected URL, (2) the Play Clip control can be clicked to play a clip from the selected URL, (3) the Launch control can be clicked to launch the selected URL location, and (4) the Edit control can be clicked to edit the selected URL (see EDITOR mode).

FIG. 5 shows an example of a Blog Page 30 according to an embodiment of the present invention. The Blog Page 30 provides the following functions: Blog Subjects 32, Blog Calendar 34, Blog Search 36, Blog Post 38, the VBPlayer 10 (described above), and Blog Replies 40. These are standard features of most modem blog pages. Subjects 32 is the list of current subjects being discussed on this blog; the calendar 34 is a representation, in calendar format of what days have blog entries, allowing the viewer to click on a day (or scroll the calendar to a previous month) and see the blog entries for the selected day; search command 36 is the ability to put a word (or words) into the field and have the blog page search for any blog entries that contain the searched for terms; blog posts 38 is the current post in the blog that is being viewed (possibly including video); Blog Replies 40 is the list of entries from viewers of the Blog Post 38 possibly including editing of the blog video.

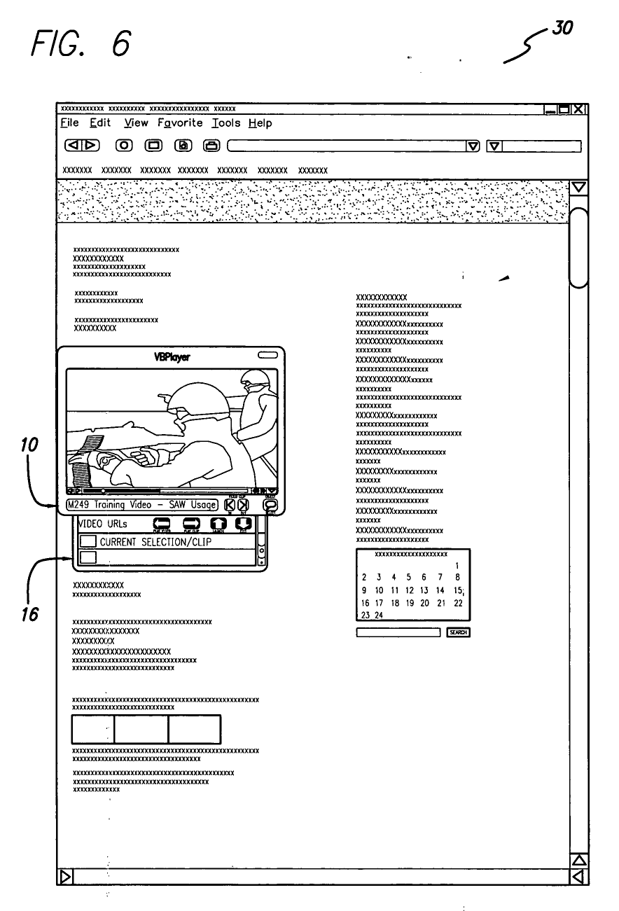

FIG. 6 shows an example of watching/interacting with video using the Blog Page 30. In this example, the user selects a blog entry in any manner by which such selection is normally made e.g. direct link to page from some other web site or blog entry; via blog calendar 34 or blog search 36 or even via link from blog replies 40. If this blog entry contains a video, then the VBPlayer 10 is launched and the video can be played by pressing the play button in the video controls 20. When the video is playing, the URL window 16 will be populated with URLs for the video as created by the blogger and represented in the URL that invoked this VBPlayer for this viewing.

FIG. 7 shows an example of a user launching a URL from the Blog Page 30. To invoke a URL, using the VBPlayer 10 the user chooses a URL and clicks the Launch control in the URL Window 16, wherein the URL Target 31 (e.g., web site) is launched.

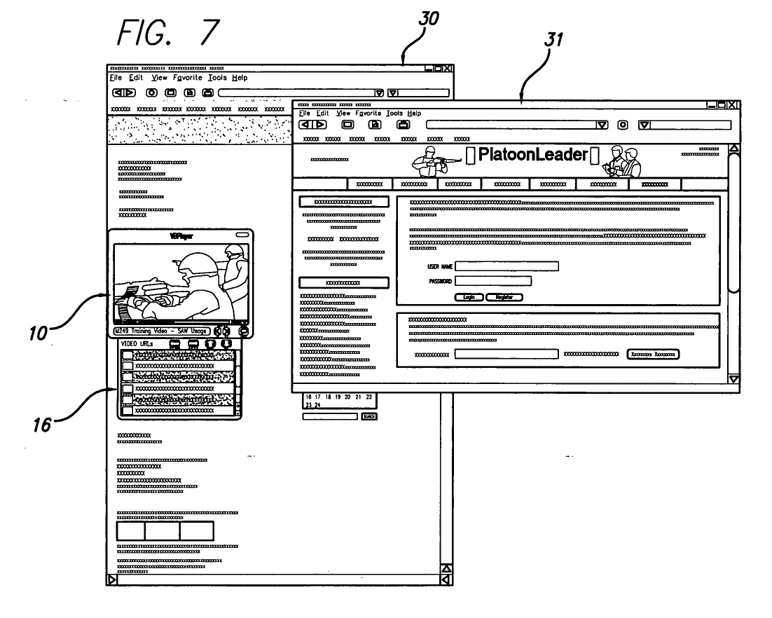

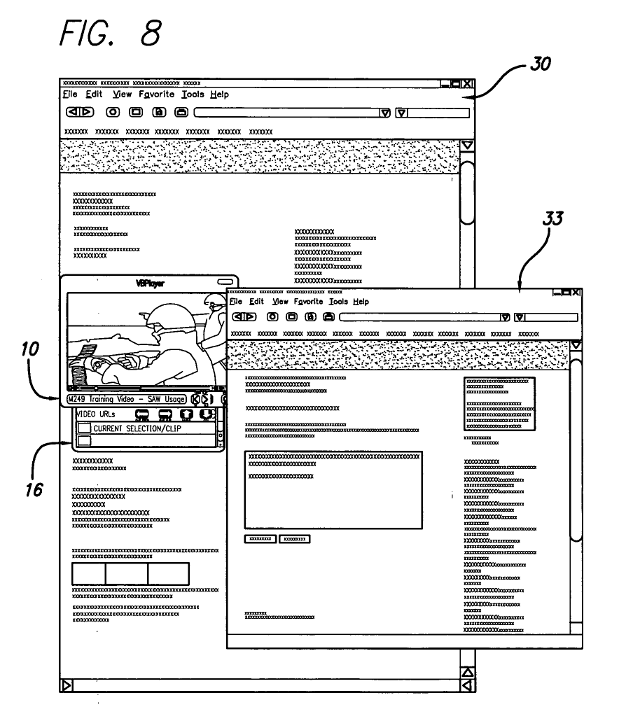

FIG. 8 shows an example of a user commenting on a video clip on the Blog Page 30, including the steps of, on the VBPlayer 10: (1) clicking Edit, (2) moving or scrubbing the video via the timeline slider in the video controls 20 to a desired In point, (3) clicking the “In” button, (4) moving or scrubbing the video via the timeline slider in the video controls 20 to a desired Out point, (5) clicking the “Out” button, (6) clicking Edit again (to stop editing) and (7) clicking Copy/Paste first URL into the blog page 33. Blog page 33 is a typical “comment” page that is invoked on most blogging software that allows a viewer to make a comment on a blog posting.

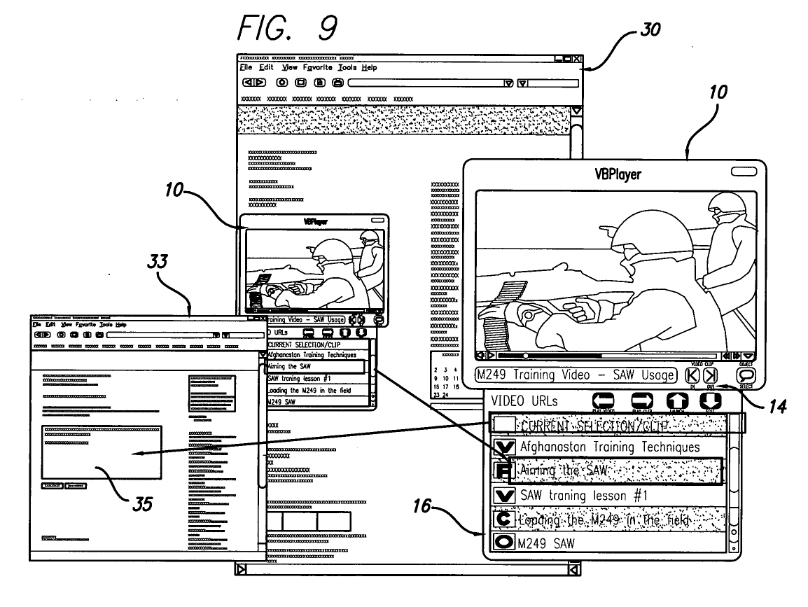

FIG. 9 shows an example of a user editing a URL on the Blog Page 30. One of the features of “editing a video” includes the notion of editing the URLs associated with a video. FIG. 9 represents the process of “editing” one of a video's URLs and not just editing the video in/out/object contents. The VBPlayer 10 is shown enlarged on the right side of the Blog Page 30 for ease of understanding. In operation, using the VBPlayer 10, the user performs the steps of: (1) clicking Edit, (2) selecting a URL, (3) clicking on the selected URL to edit the URL, (4) typing in URL changes 35 in the video clip, (5) backspacing to delete URL wherein URL name comes from the Blog page 33, (6) Right-clicking on the URL properties and (7) when finished, using the first “magic” URL to “save” the URL edits. The Green-line represents the video being chosen to edit (for instance, changing the destination of a URL associated with the video). The pink line represents copy/pasting the updated video's “magic URL” (highlighted in yellow) into the Blog page comment box for posting.

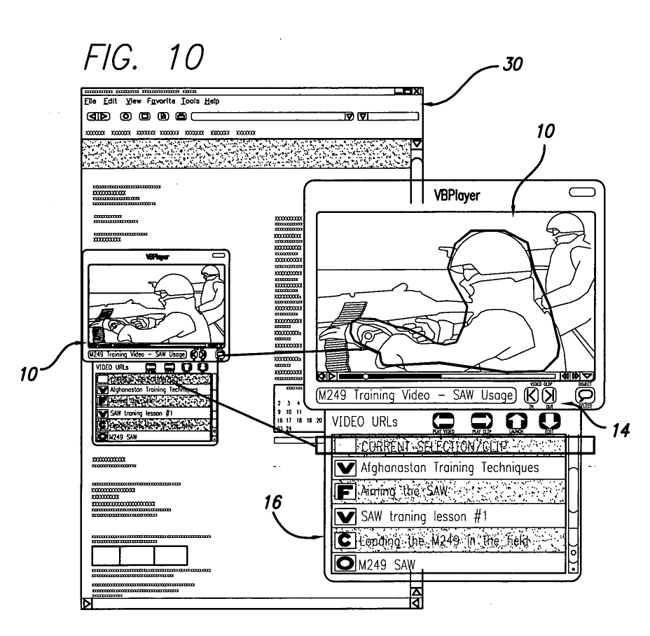

FIG. 10 shows an example of a user tracking an object in a scene in VBPlayer on the Blog Page 30, including the steps of, on the VBPlayer 10: (1) clicking Edit, (2) selecting track object, (3) drawing a line around an object 37, (4) clicking Edit again wherein the Blog page 30 identifies the object's edges, tracks the object 37 until lost and sets first “magic” URL to the object, and (5) user dragging/dropping the first URL into list in the VBPlayer URL window 16. In this process the green arrow shows that when the edit button is pressed, the VBPlayer is launched in a separate window with the ability to edit the video enabled. After the tracking is done the VBPlayer's “magic URL” (highlighted e.g., in Yellow) is dragged-dropped (preferably contrasting highlight or color, e.g., a Pink Line) onto the Blog Page 30 player URL List 20 for insertion.

FIG. 11 shows an example of a user creating a “play list” on the Blog Page 30, including the steps of, on the VBPlayer 10: (1) clicking Edit, (2) clicking Move video to in-point, (3) clicking “In”, (4) clicking Move video to out-point, (5) clicking “Out”, (6) dragging first “magic” URL into URL window 16 (7) repeating as necessary, (8) when finished, clicking Edit again wherein the video in is now in the “play list” and (9) using the first “magic” URL to identify the composite list of the Clips in the URL Window 16. This “magic URL” can be used now to identify this play-list of clips and video segments. It should be noted that the “magic URL” (first URL pointing to the original source video) is held or stored akin, in one embodiment, to how a “history” feature of a software browser stores the first URL that has been visited. One can open a “new window” and store another URL as the first URL in that new window. The new window is akin to a new source or original video.

In summary, in one embodiment the example VBPlayer 10 provides the following commands or functions:

Video and Edit controls:
Play/Pause/Stop, FF/Rew, (shift) Select, In-Out-Edit, Tracking objects.

URL Control & Types:
Types:
   First (1^{st})—URL “magic” represents selected video or Object with all associated metadata
   “V”—Video—associated with whole video
   “C”—Clip—associated only with a subset (segment) video (clip)
   “F”—Frame—associated only with single framne (image)
   “O”
      Object—associated with a (tracked) Object
Controls:
   Play from beginning—start video where URL first appears
   Play from Click—start video where URL was clicked into list
   Launch URL—invoke whatever the URL points to (e.g., web, media)
   Edit—put player into Edit mode on selected URL

The VBPlayer 10 can be implemented in standard technologies such as Flash, QuickTime, WM, Real Player, etc. The VBPlayer 10 provides basic paradigms on the Web and Media Players, including features such as Copy/Paste, Drag/Drop, URLs, standard buttons, etc. The VBPlayer 10 “backend” hosts (XML) metadata wherein video files are stored on existing servers (e.g., for a tracking engine). The VBPlayer 10 is “skinable” and business-rules can be enforced, e.g., “edited” videos forced into branded player or to use a Digital Rights Management system (DRM). The VBPlayer 10 can be easily integrated into standard blogging-engines, and provides reporting, metric capabilities and the like.

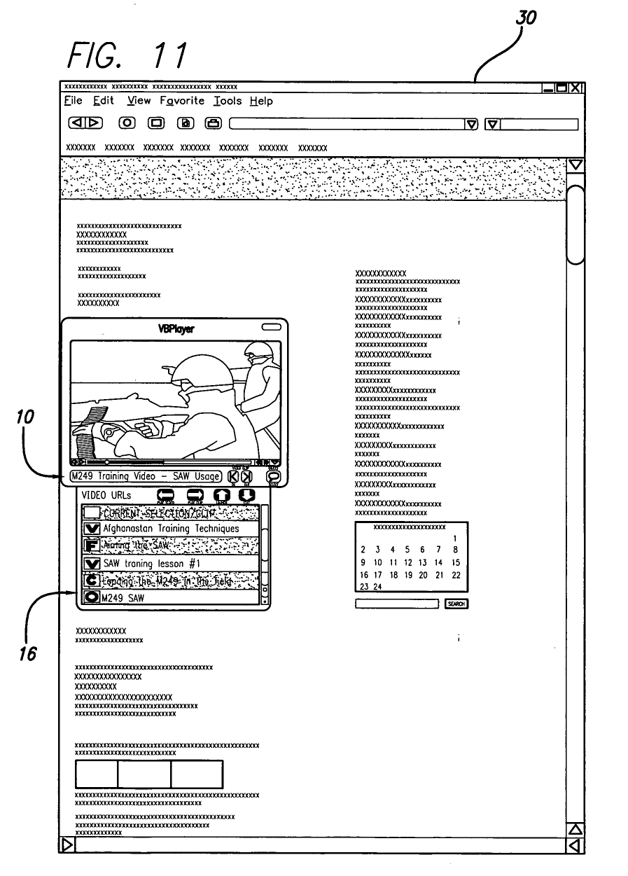

Referring now to the example block diagrams in FIGS. 12-13 and the example flowcharts in FIGS. 15-21, another embodiment of the present invention utilizing a VBPlayer as described above, is presented below.

FIG. 12 shows an example block diagram of a video web logging system 50 according to an embodiment of the present invention. The system 50 comprises a web log server 51, a web page sender client 52, a video server 53, a VB log XML server 54, and an object tracking server 55. In this example, the system 50 is connected to the Internet 55.

The web log server 51 includes web log software 100 and storage 111. The web page sender client includes a web browser 120, a media player 121, a VB log player 123 and storage 122. The video server 53 includes media server software 130 and storage 131. The VB Log XML server includes XML software & data base module 140 and storage 141. The object tracking server includes object tracking software 150 and storage 151. In the system 50 the components shown are logical devices/modules. A such, for example, any/all machines/servers/clients/software can be in the same physical computer or in separate computers.

FIG. 12 further shows various types of data communicated between the different components of the system 50. The web log software 100 sends web pages to the web browser 120 and receives URL(s) from the web browser 20. The web browser 120 sends URL(s) to the Internet 55 and receives web pages from the Internet 55. The media player 121 sends URL/other address to the media server software 130 and receives media content from the media server software 130. The media server software 130 sends media metadata to the XML server & data base module 140. The module 140 sends XML data to the object tracking software 150 and receives URL(s) from the object tracking software 150. The module 140 sends URL and XML description data to the VB Log player 123. The VB Log Player 123 controls the media player 121.

The web log software 100 can comprise: movable type, type pad, blogger, etc. The web browser 120 can comprise Microsoft Internet Explorer, Mozilla Firefox, etc. The media player 121 can comprise Quicktime player, Windows media player, Real Player, Java player, etc. The VB Log player 123 comprises the VBPlayer 10 as described above. The media server software 130 can comprise Quicktime Server, Windows media server, Real media server, etc. The module 140 comprises a backend XML server described above.

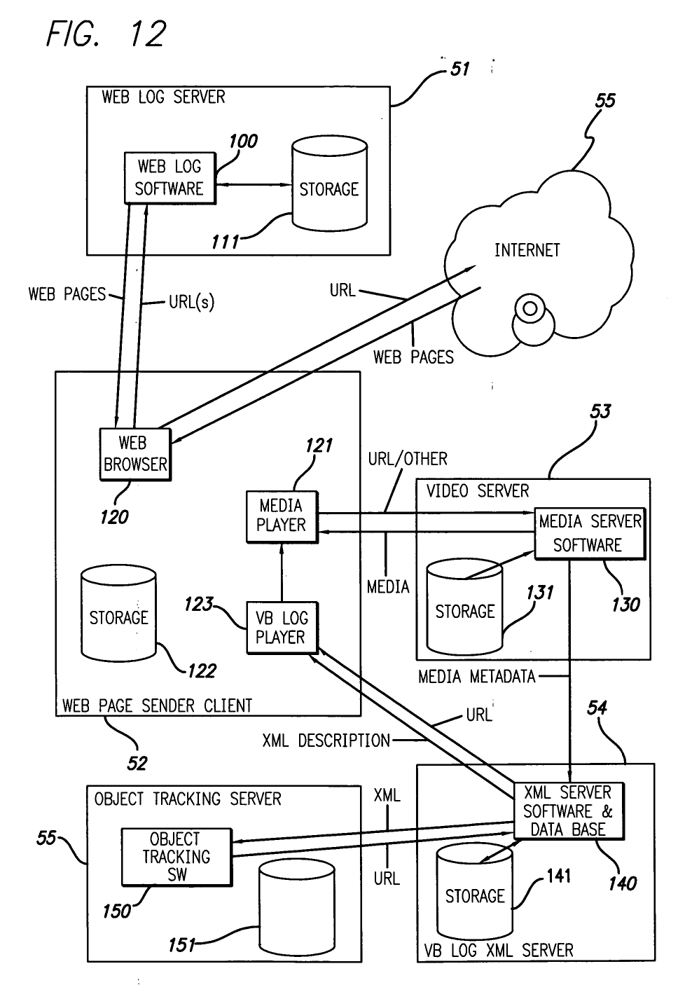

FIG. 13 shows example functions of the vblog player 123, including: edit controls 124, URL controls 125, URL window 126 and current video/status display 127 (examples of which were described in relation to FIGS. 1-11 above). FIG. 14 shows example functions of the module 140, including: input comments/actions from player function 142, store XML description by ID function 143 and retrieve XML description by ID function 144.

The steps in the flowcharts of FIGS. 15-21, implemented in the system 50, are now described.

Referring to the example flowchart in FIG. 15, an example of watching a video in a blog (e.g., play, stop, etc.) in the system 50 includes the steps of:

200: Load Blog page from the server 100 to the browser 120;

202: The web page browser 120 loads the embedded vblog player 123 which contains a video player window 52;

204: User provides commands by pressing play, pause, fwd, rev, drags, scrubs, etc.;

206: User command is sent to video server 130;

208: Video rendered to window appropriately by the video server 130;

210: User clicks on VBLOG URL in VBLOG page;

212: Determine if URL points to VBLOG page;

214: If not, load page according to URL, otherwise proceed back to step 202.

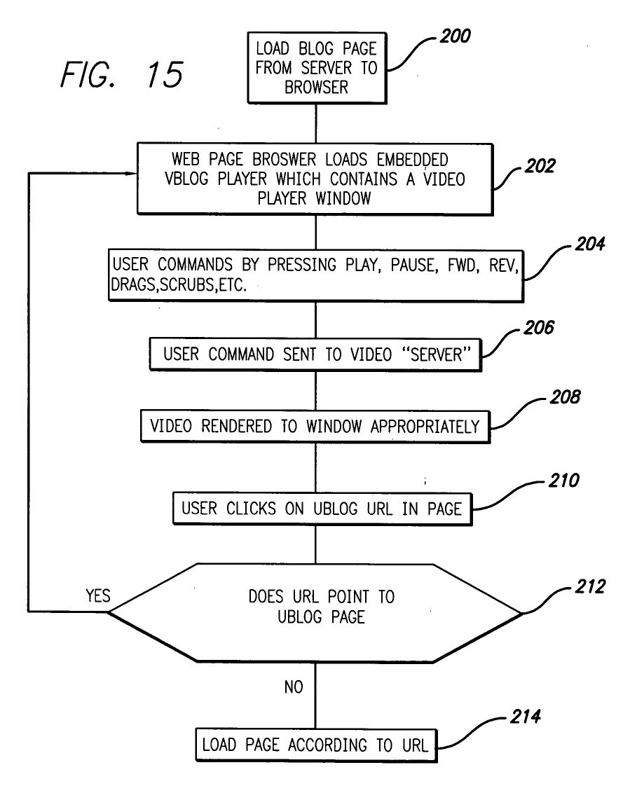

The interrelated flowcharts in FIGS. 16 and 17 are now described. The flowchart in FIG. 16 shows example steps of “Editing” a video, and the flowchart in FIG. 17 shows example steps of Inserting a URL. Referring to FIG. 16, “Editing” a video includes the steps of:

300: Invoke Video In VB Log Player (123);

302: Press Edit (124);

304: Locate in-point via play, pause, FF, RW or scrub;

306: Press IN (124);

308: Locate out-point via play pause, FF, RW, or scrub;

310: Press OUT (124);

312: Generate description & ID to send to XML server (140) with data;

314: Generate URL to invoke server with Data;

316: Place URL in “magic” URL spot #1, whereby the “magic” URL is created;

318: User cuts/pastes drags/drops this URL into any place URL can be used (e.g., BLOG comment, e-mail web browser, etc.), and process proceed to step 414 in FIG. 17 described below.

Referring to the flowchart in FIG. 17 an example of Inserting a URL includes the steps of:

400: Invoke video in VBLOG player (123);

402: Press Edit (124);

404: Copy URL from any location;

406: Paste URL into next open space in URL window;

408: Update message to XML server 140;

410: Determine if another URL from play needed? If so, go to step 304 in FIG. 16;

412: Otherwise, determine if another URL is to be pasted? If so, go to step 404;

414: Otherwise, determine if URL is to be pasted in URL window? If so, go back to step 406;

416: Otherwise, press Edit (124) to end edit;

418: Send message to XML server 140 to finalize video.

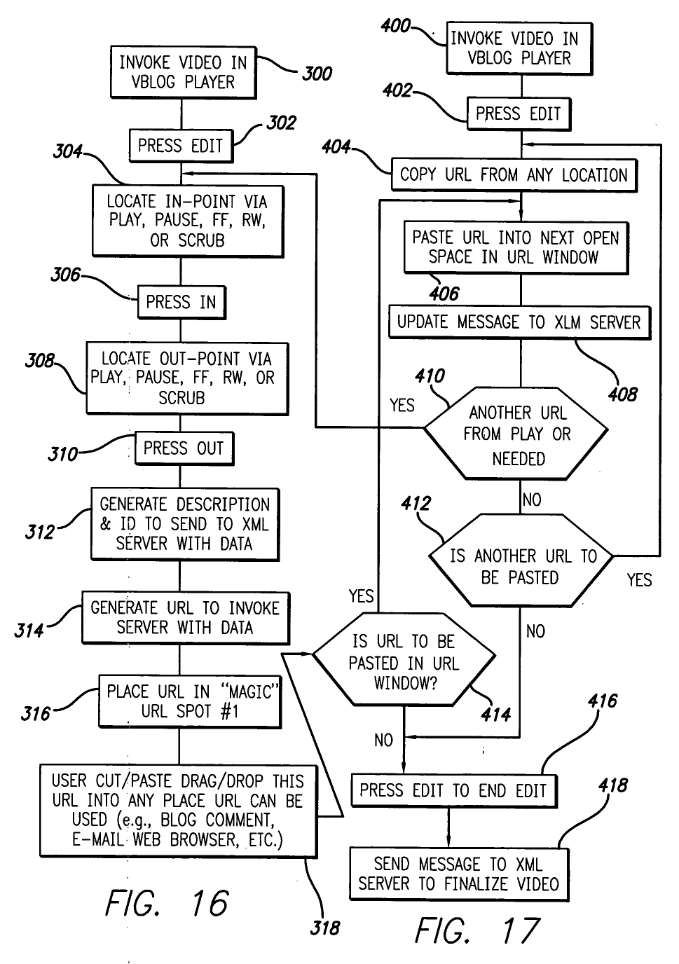

The flowchart in FIG. 18 shows example steps of launching a URL, including:

500: Invoke VBLOG Player (123);

502: Locate target URL in URL window (120);

504: Double click URL;

506: Invoke URL;

508: Determine if URL points to VBLOG player (123)?

510: If so, load VBLOG player window;

512: Otherwise, load web page or any other resource.

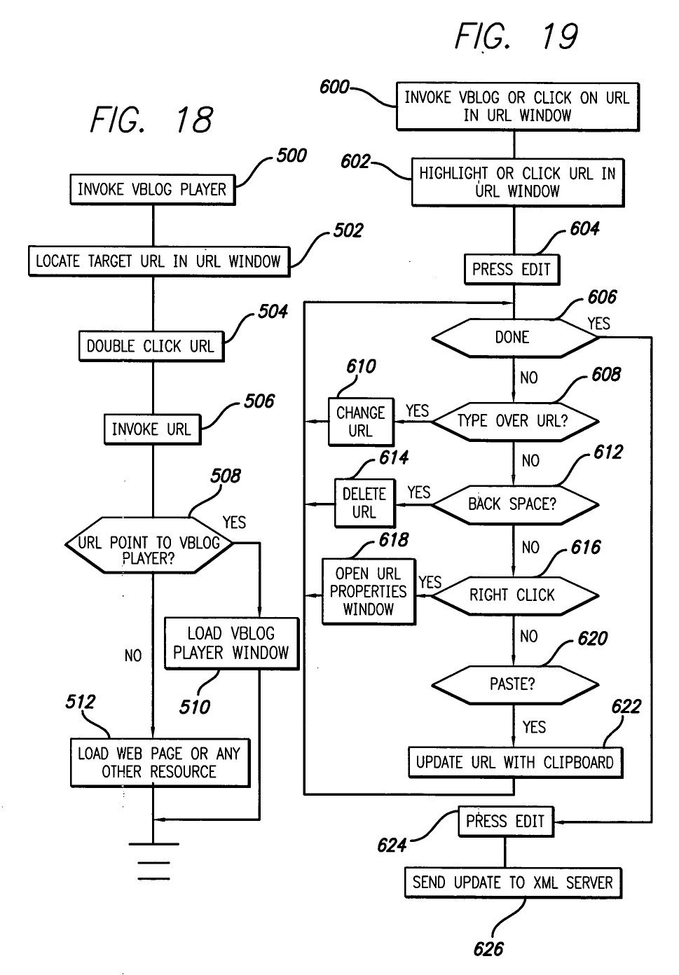

The flowchart in FIG. 19 shows example steps of Editing a URL, including:

600: Invoke VBLOG player (123);

602: Highlight or click on URL in URL window;

604: Press Edit;

606: If the user is done, then proceed to step 622;

608: Otherwise, is user typing over a URL?

610: If so, change the URL and proceed to step 606;

612: Otherwise, is user back spacing?

614: If so, then delete URL and proceed to step 606;

616: Otherwise, is the user right clicking on the mouse to see URL properties?

618: If so, open URL properties window and proceed to step 606;

620: Otherwise, is the user pasting text over the URL? If not, proceed to step 606;

622: Otherwise, update URL with clipboard, and proceed to step 606;

624: User is done editing URL and presses Edit;

626: Send updated URL to the XML server 140.

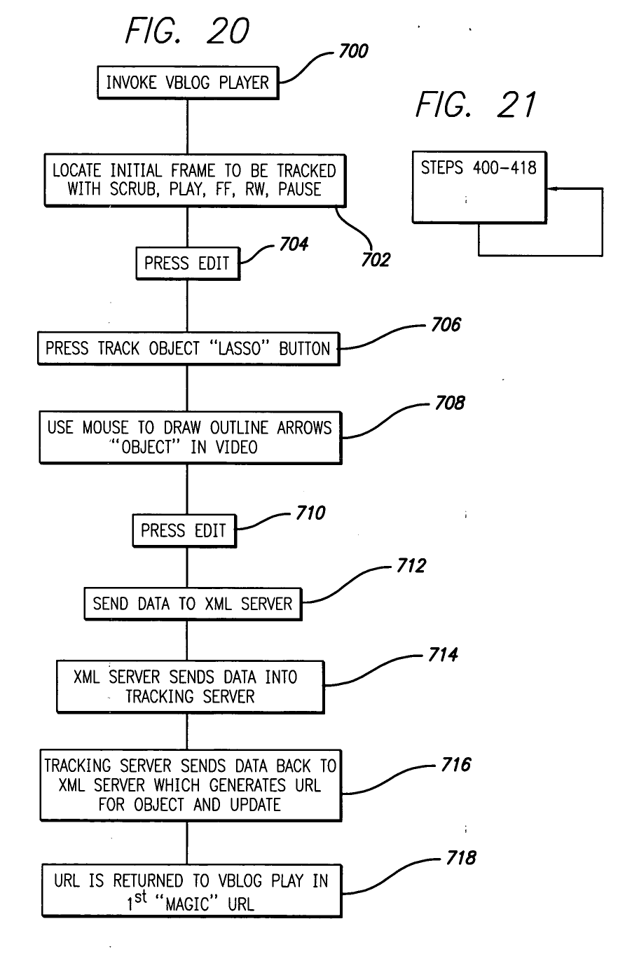

The flowchart in FIG. 20 shows example steps of tracking an object, including:

700: Invoke VBLOG player (123);

702: Locate initial frame to be tracked with scrub, play, FF, RW, pause;

704: Press Edit;

706: Press track object “lasso” button;

708: Use mouse to draw outline arrows “object” in video;

710: Press Edit;

712: Send data to XML server 140;

714: XML server sends data to tracking server 55;

716: Tracking server 55 sends data back to XML server 140 which generates URL for object and updates;

718: URL is returned to VBLOG player as 1st “magic” URL.

The flowchart in FIG. 21 shows step 800 of generating a play list which essentially comprises steps 400-418 of FIG. 17 in repetition for a play list.

The steps in the flowcharts of FIGS. 15-21 are only examplary, and those skilled in the art will recognize that other implementations of the steps of the present invention are possible and contemplated by the present invention.

As such, the present invention provides an efficient, useful and practical method of integrating video into blogs such that the paradigm of blogging can be applied to video as it has been applied to text. In such an embodiment, a user is provided with the ability to post videos, revise videos, comment on videos, have others comment on videos, syndicate videos, track videos, etc. In one implementation of such a preferred embodiment, such features are accomplished by integration of video into a blog environment such that blog-functions (e.g., posting, revising, commenting, quoting whole or subsets of video, syndication, tracking, etc.) are applied to video. This allows a user to treat video (including tracked “objects” in the video) as if it were text in the context of modem text-blogging.

The present invention has been described in considerable detail with reference to certain preferred versions thereof; however, other versions are possible. Therefore, the spirit and scope of the appended claims should not be limited to the description of the preferred versions contained herein.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

What is claimed is:

1. A method of video web logging comprising the steps of:
maintaining a web log for one or more videos on a server;
providing a web log page for user interaction with the web log; and
providing web log functions in the web log page for user application to the web log.

2. The method of claim 1 wherein the step of providing the web log functions further includes providing a video window for playing a selected video for the user.

3. The method of claim 2 wherein the step of providing the web log functions further includes providing an address window and displaying a URL of the selected video on the server in the address window.

4. The method of claim 3 wherein each URL is of a type Video, Clip, Frame or Object.

5. The method of claim 2 wherein the step of providing the web log functions further includes displaying the name of the selected video.

6. The method of claim 3 wherein the step of providing the web log functions further includes launching a URL of the selected video in response to a user request.

7. The method of claim 6 wherein the step of providing the web log functions further includes the steps of allowing a user to copy a selected video URL into the web log.

8. The method of claim 6 wherein the step of providing the web log functions further includes the steps of providing a list of selected video URLs for user editing.

9. The method of claim 2 wherein the step of providing the web log functions further includes providing video controls for user control over playing of the selected video.

10. The method of claim 9 wherein the step of providing the web log functions further includes providing edit controls for user selection of portions of one or more video frames in the selected video.

11. The method of claim 10 wherein the step of providing the web log functions further includes tracking said user selected portions over multiple frames.

12. The method of claim 3 wherein the step of providing the web log functions further includes providing URL controls for user interaction.

13. The method of claim 12 wherein the URL controls include: Play Video control to play video from a selected URL, Play Clip control to play clip from a selected URL, Launch control to launch a selected URL, and Edit control to edit a selected URL.

14. The method of claim 1 wherein the step of providing the web log functions further includes providing on the web log page one or more of: Blog Subjects, Blog Calendar, Blog Search, Blog Post and Blog Replies.

15. A method of video web logging on a web log page of a web log server, the method comprising the steps of:
providing web log functions for the web log page for user application to the web log,
wherein the web log functions include a step of providing a video window for playing a selected video for the user.
